(19) United States
(12) Patent Application Publication
(10) Pub. No.: US 2026/0125123 A1
(43) Pub. Date: May 7, 2026

(54) ENDLESS TRACK, TRACK SYSTEM, AND VEHICLE FOR USE WITH SAME

(71) Applicant: SOUCY INTERNATIONAL INC., Drummondville (CA)

(72) Inventors: Magella BEDARD, Drummondville (CA); Remi HAMELIN, Trois-Rivieres (CA); Olivier LECLERC, Drummondville (CA); Marc-Antoine LEBLANC, Drummondville (CA); Francois LAFLAMME, St-Germain-De-Grantham (CA)

(21) Appl. No.: 19/118,246

(22) PCT Filed: Oct. 5, 2023
(86) PCT No.: PCT/CA2023/051320

§ 371 Date: Apr. 3, 2025

Related U.S. Application Data
(60) Provisional application No. 63/414,367, filed on Oct. 7, 2022.
(60) Provisional application No. 63/455,433, filed on Mar. 29, 2023.

(51) Int. Cl. B62D 55/24; B62D 55/02; B62D 55/06; B62D 55/125

(52) U.S. Cl. CPC B62D 55/244; B62D 55/02; B62D 55/06; B62D 55/125

(57) ABSTRACT

An endless track, a track system, a kit, and a vehicle are provided. The carcass of the endless track includes a plurality of members disposed in the carcass and which extends laterally in the inner portion of the carcass and are longitudinally spaced from one another along the carcass. A given member from the plurality of members has a guiding portion configured to engage the wheel and which extends radially inwardly from the inner surface of the inner portion of the carcass, and a reinforcing portion located in the inner portion of the carcass and which extends laterally between at least the first driving lug and at least the second driving lug. The reinforcing portion is configured to reinforce the inner portion of the carcass and support weight of the wheel.

### CROSS-REFERENCE TO RELATED APPLICATIONS

The present application claims priority to U.S. Provisional Patent Application No. 63/414,367, filed Oct. 7, 2022, and U.S. Provisional Patent Application No. 63/455,433, filed Mar. 29, 2023, both of which are incorporated by reference herein in their entirety.

### TECHNICAL FIELD

The present application generally relates to endless tracks, track systems, and vehicles having track systems.

### BACKGROUND

Various vehicles, such as military vehicles or agricultural vehicles come equipped with track assemblies instead of tires for a variety of reasons, notably to have enhanced traction on various ground surfaces that are soft, slippery and/or uneven (e.g., soil, mud, sand, ice, snow, etc.).

Conventionally, the track assemblies in some of these vehicles, particularly military vehicles, come equipped with metallic endless tracks. These metal endless tracks can be heavy, can be burdensome to install, can make a lot of noise, and can cause a lot of vibrations, which can reduce life of some components of the vehicle while also negatively impacting ride quality.

U.S. Pat. No. 10,501,131, incorporated herein by reference, discloses a plurality of primary load distribution members positioned transversely and distributed longitudinally in a carcass of a track assembly so as to distribute at least parts of downward wheel forces applied by at least one of the wheels when the track is being driven down onto the wheel-facing side of the carcass into the traction surfaces via flexion of the primary load distribution members.

Nevertheless, there is a desire for a track assembly that could mitigate the above-mentioned issues.

### SUMMARY

It is an object of the present technology to ameliorate at least some of the inconveniences present in the prior art.

It should be noted that at least some conventional endless tracks have reinforcement members located in an outer portion of their carcass. Developers of the present technology have realized at least some drawbacks with such solutions.

In the context of the present technology, there is provided an endless track having an elastomeric carcass with a member having a guiding portion and a reinforcing portion. In some embodiments, the guiding portion and the reinforcing portion can be integrally formed and/or manufactured from a rigid material. A rigid member, as opposed to a resilient member, for example, may be employed to avoid and/or reduce deformation and/or bending of the member so as to retain its shape when force is applied thereto during operation. It is contemplated that the rigidity of the integrally formed member may be provided at least in part by its geometrical configuration (e.g., a T-shaped member). It is also contemplated that the rigidity of the integrally formed member may be provided at least in part by the material used for manufacturing the member (e.g., cast iron, titanium, steel, etc.).

The reinforcing portion extends laterally in an inner portion of the carcass and is configured to reinforce the carcass and support weight of a vehicle. It is contemplated that reinforcing portions of the plurality of members, and potentially longitudinal cables, may exclusively support the weight of the vehicle, without requiring additional types of reinforcing members in the carcass for that purpose. The guiding portion extends inwardly from the inner portion of the carcass and is configured to reinforce a guiding lug of the carcass. The guiding portion may be exposed.

The reinforcing portion may be located in the inner portion of the carcass and, in a sense, “sit” on one or more layers of reinforcing cords. The reinforcing portion may or may not be in direct contact with the layer(s) of reinforcing cords. It is contemplated that the reinforcing cords may provide longitudinal reinforcement to the carcass, while the reinforcing portion may provide lateral reinforcement to the carcass.

It is contemplated that providing the reinforcing portion in the inner portion of the carcass, such that it sits on the layer(s) of reinforcing cords, may avoid having reinforcement members in the outer portion of the carcass. It is contemplated that avoiding reinforcement members in the outer portion of the carcass may be beneficial as it reduces dimensional limitations on shape, size and pattern of outer lugs of the carcass.

It is contemplated that providing a reinforcing portion in the inner portion of the carcass, such that it sits on the layer of reinforcing cords, may reduce wear of the carcass and/or the layer(s) of reinforcing cords. Providing a reinforcing portion that extends in the inner portion of the carcass provides a reinforcing barrier between a wheel assembly of a track system and the layer(s) of reinforcing cords, and aids in supporting and distributing weight of the vehicle. It is contemplated that providing such a reinforcing barrier between the wheel assembly and the reinforcing cords may reduce the risk of said reinforcing cords migrating in the carcass and/or getting exposed.

In some embodiments, developers have devised an endless track with a reduced width of the guiding portion and/or of the guiding lug. It is contemplated that for an endless track with a pre-determined width, having narrower guiding lugs provides additional room for enlarging the one or more road wheel paths on the inner surface of the carcass. It is also contemplated that providing a narrower guiding lug may help during installation of the endless track on a track system. It is contemplated that an increased width of road wheel paths may result in an increased lateral flexibility of the carcass, and which may also help during installation of the endless track on the track system.

It is contemplated that reducing a width of the guiding portion and/or of the guiding lug may result in an endless track that is comparatively narrower than a conventional endless track used for a vehicle of a given weight. Developers have also realized that due to the reinforcing member being located in the inner portion of the carcass, shape, size and/or pattern of outer lugs may be more freely selected for providing desired traction to the track system. For example, such carcasses may be provided with comparatively deeper and/or longer outer lugs that some conventional carcasses used for a vehicle of a given weight. In some embodiments, providing deeper and/or longer outer lugs may allow compensating for a potential reduced width of the outer lugs.

It is contemplated that it may be desirable to reduce the width of the carcass for a variety of performance metrics of the track system.

In some implementations of the present technology, the endless track may be designed based on a width requirement for a road wheel path on the inner surface of the carcass. In some cases, a width of driving lugs may be pre-determined and, as a result, a width of the guiding lug may be determined as a difference between (i) a maximum allowable width of the carcass, and (ii) a sum of a width of the road wheel path and the pre-determined width of the driving lugs. In these implementations, the width requirement for the road wheel path may be determined based on a weight of the vehicle, a size of the wheels of the track system, and/or an other performance metric of the track system.

Developers have designed an endless track with a specific given member allowing for a narrowing of a guiding lug, and therefore of the carcass itself. The given member is designed in a manner that reinforces a guiding lug (allowing it to be narrower), reinforces the carcass, and supports weight of the vehicle.

In one implementation, a carcass may be designed for vehicles weighing about 45 US tons. In this implementation, it may be desirable to increase the width of the road wheel path while maintaining a maximum allowable width of the carcass. For example, it may be desirable to increase a width of the road wheel path while maintaining a total width of 530 mm for the carcass. It should be noted that it may not be desirable to modify a width of the driving lugs as it may impact one or more performance metrics of the endless track and/or the track system. As such, in these embodiments, reducing the width of the guiding lug may provide additional room for increasing the width of the road wheel path. In this implementation, a carcass with the given member may allow reducing the width of the guiding lug from 65 mm to 35 mm, for example.

In an other implementation, it may be desirable to reduce the width of the carcass itself, as opposed to reducing the width of the road wheel path. In these implementations, once the width of the road wheel paths is determined, a minimum width of the guiding lugs is selected for a given performance metric of the endless track and/or the track system. For example, such an approach may be useful when designing the endless track for use with comparatively lighter vehicles (e.g., vehicles weighing 5 US tons instead of 45 US tons). In these cases, a carcass may be designed with narrow guiding lugs and still being within performance requirements of the endless track. Such an endless track may also be less expensive to produce as it may require comparatively less material than conventional endless tracks.

It should be noted that, although reducing the width of the carcass may reduce a width of outer lugs of the carcass, developers have designed a carcass with a given member located in the inner portion of the carcass and which allows increasing length of the outer lugs, and thereby compensating for their reduced width.

In yet a further implementation, it may be desirable to increase the width of the road wheel path by reducing the width of the guiding lug for operating in combination with comparatively wider wheels. It should be noted that increasing the width of road wheel paths for using wider wheels results in reduced pressure on the carcass and which allows using comparatively less expensive resilient materials for manufacturing the carcass.

In a first broad aspect of the present technology, there is provided an endless track for a track system. The endless track is engageable with a wheel of the track system. The endless track comprises a polymeric carcass. The carcass includes an outer portion with an outer surface for contacting a ground surface. The carcass includes an inner portion with an inner surface opposite to the outer surface. A first lateral surface of the carcass extends between the inner and outer surfaces, and a second lateral surface of the carcass opposite to the first lateral surface and extends between the inner and outer surfaces. The carcass includes a plurality of driving lugs configured to engage the wheel and disposed on the inner surface proximate to the first and second lateral surfaces, the plurality of driving lugs extending radially inwardly from the inner surface and being longitudinally spaced from one another along the inner surface. The plurality of driving lugs includes a first driving lug disposed proximate to the first lateral surface and a second driving lug disposed proximate to the second lateral surface. The carcass includes a plurality of members disposed in the carcass, the plurality of members extends laterally in the inner portion of the carcass and being longitudinally spaced from one another along the carcass. A given member from the plurality of members has a guiding portion configured to engage the wheel and extending radially inwardly from the inner surface of the inner portion of the carcass, and a reinforcing portion located in the inner portion of the carcass and extending laterally between at least the first driving lug and at least the second driving lug. The reinforcing portion is configured to reinforce the inner portion of the carcass and support weight of the wheel.

In some embodiments of the endless track, the given member is a T-shaped member.

In some embodiments of the endless track, the guiding portion and the reinforcing portion are integrally formed.

In some embodiments of the endless track, the given member is made from a rigid material.

In some embodiments of the endless track, the plurality of members is a plurality of first members. The endless track further includes at least one second member configured to reinforce the carcass, the at least one second member extending in the inner portion of the carcass longitudinally along a length of the carcass and about the plurality of first members, such that the reinforcing portion is located between the inner surface of the inner portion and the at least one second member.

In some embodiments of the endless track, the at least one second member is a plurality of second members arranged into at least one layer of second members.

In some embodiments of the endless track, the at least one layer of second members is a layer of reinforcing cords.

In some embodiments of the endless track, the carcass further includes a guiding lug for guiding the wheel and disposed on the inner surface between the first driving lug and the second driving lug, the guiding portion extending into the guiding lug.

In some embodiments of the endless track, the inner surface defines a wheel path located laterally between the first driving lug and the guiding lug, the wheel path configured to engage the wheel, the wheel path has a first width on the inner surface of the inner portion, the guiding lug has a second width on the inner surface of the inner portion, the first driving lug has a third width, and the carcass has a fourth width.

In some embodiments of the endless track, the first width is between 120 mm and 155 mm.

In some embodiments of the endless track, the first width is 137.5 mm.

In some embodiments of the endless track, the first width is 149.2 mm.

In some embodiments of the endless track, the second width is between 20 mm and 80 mm.

In some embodiments of the endless track, the second width is 35 mm.

In some embodiments of the endless track, the second width is less than 40 mm.

In some embodiments of the endless track, a ratio of the second width over the first width is between 0.22 and 0.35.

In some embodiments of the endless track, a ratio of the second width over the fourth width is between 0.06 and 0.08.

In some embodiments of the endless track, a ratio of the first width over the fourth width is between 0.21 and 0.28.

In some embodiments of the endless track, a ratio of the third width over the fourth width is between 0.21 and 0.19.

In some embodiments of the endless track, a ratio of the second width over the first width is below 0.4.

In some embodiments of the endless track, a ratio of the second width over the fourth width is below 0.85.

In some embodiments of the endless track, the endless track further includes a plurality of non-linear outer lugs extending radially outwardly from the outer surface of the outer portion and longitudinally spaced from one another along the outer surface.

In some embodiments of the endless track, the plurality of non-linear lugs includes a first non-linear outer lug having a non-linear section extending laterally between the first and second lateral surfaces.

In some embodiments of the endless track, the non-linear section is a chevron-like section.

In some embodiments of the endless track, the first non-linear outer lug further includes at least one linear section disposed proximate to at least one of the first and second lateral surfaces.

In some embodiments of the endless track, the at least one linear section includes a first linear section and a second linear section, the first linear section disposed proximate to one of the first and second lateral surfaces and the second linear section disposed proximate to the other one of the first and second lateral surfaces.

In some embodiments of the endless track, the plurality of non-linear lugs defines a bi-directional pattern.

In some embodiments of the endless track, the wheel is a sprocket wheel, the sprocket wheel being configured to engage the plurality of driving lugs for transmitting force to the endless track.

In some embodiments of the endless track, the sprocket wheel includes a rim and a plurality of engaging elements extending laterally away from the rim and being circumferentially spaced along the rim, the plurality engaging elements configured to engage with the plurality of driving lugs in an internal drive configuration.

In some embodiments of the endless track, the plurality of engaging elements are circumferentially spaced along the rim according to a first pitch, the plurality of driving lugs being longitudinally spaced along the inner surface according to a second pitch, the first pitch being different from the second pitch.

In some embodiments of the endless track, the second pitch is smaller than the first pitch.

In some embodiments of the endless track, the second pitch is larger than the first pitch.

In some embodiments of the endless track, the track system is operatively connected to an engine of a vehicle.

In some embodiments of the endless track, the vehicle is a military vehicle.

In some embodiments of the endless track, the vehicle is an agricultural vehicle.

In a second broad aspect of the present technology, there is provided a member for an endless track engageable with a wheel, the endless track including a polymeric carcass including an outer portion with an outer surface, an inner portion with an inner surface, and a plurality of first driving lugs disposed on the inner surface proximate to a first lateral edge of the inner portion and a plurality of second driving lugs disposed on the inner surface proximate to a second lateral edge of the inner portion, the member having: a guiding portion configured to engage the wheel and extending from the inner surface of the inner portion of the carcass, the guiding portion extending away from the inner and outer surfaces, and a reinforcing portion located in the inner portion of the carcass and extending laterally between one of the plurality of first driving lugs and one of the plurality of second driving lugs, the reinforcing portion being configured to reinforce the inner portion of the carcass and support weight of the wheel.

In a third broad aspect of the present technology, there is provided a kit for a track system comprising a wheel and a polymeric carcass. The carcass includes an outer portion with an outer surface for contacting a ground surface and an inner portion with an inner surface opposite to the outer surface. A first lateral surface of the carcass extends between the inner and outer surfaces, and a second lateral surface of the carcass opposite to the first lateral surface and extends between the inner and outer surfaces. The carcass includes a plurality of driving lugs configured to engage the wheel and disposed on the inner surface proximate to the first and second lateral surfaces. The plurality of driving lugs extends radially inwardly from the inner surface and being longitudinally spaced from one another along the inner surface. The plurality of driving lugs includes a first driving lug disposed proximate to the first lateral surface and a second driving lug disposed proximate to the second lateral surface. The carcass includes a plurality of members disposed in the carcass, the plurality of members extending laterally in the inner portion of the carcass and being longitudinally spaced from one another along the carcass. A given member from the plurality of members has a guiding portion configured to engage the wheel and extending radially inwardly from the inner surface of the inner portion of the carcass, and a reinforcing portion located in the inner portion of the carcass and extending laterally between at least the first driving lug and at least the second driving lug. The reinforcing portion is configured to reinforce the inner portion of the carcass and support weight of the wheel. A plurality of guiding lugs is configured to guide the wheel and disposed on the inner surface between the first driving lug and the second driving lug. The guiding portion extends into a given guiding lug from the plurality of guiding lugs. The inner surface defines a wheel path located laterally between the first driving lug and the guiding lug. The wheel path being configured to engage the wheel and having a width that matches a width of the wheel.

In a fourth broad aspect of the present technology, there is provided a track system for a vehicle. The track system comprises a sprocket wheel having a rim and a plurality of engaging elements extending laterally from a longitudinal center plane of the track assembly, the sprocket wheel defining a plurality of grooves between the plurality of engaging elements. The track system comprises an endless track engageable with the wheel. The endless track includes a polymeric carcass. The carcass includes an outer portion with an outer surface for contacting a ground surface. The carcass includes an inner portion with an inner surface opposite to the outer surface. A first lateral surface of the carcass extends between the inner and outer surfaces, and a second lateral surface of the carcass opposite to the first lateral surface and extends between the inner and outer surfaces. The carcass includes a plurality of driving lugs configured to engage the wheel and disposed on the inner surface proximate to the first and second lateral surfaces, the plurality of driving lugs extending radially inwardly from the inner surface and being longitudinally spaced from one another along the inner surface. The plurality of driving lugs includes a first driving lug disposed proximate to the first lateral surface and a second driving lug disposed proximate to the second lateral surface. The carcass includes a plurality of members disposed in the carcass, the plurality of members extends laterally in the inner portion of the carcass and being longitudinally spaced from one another along the carcass. A given member from the plurality of members has a guiding portion configured to engage the wheel and extending radially inwardly from the inner surface of the inner portion of the carcass, and a reinforcing portion located in the inner portion of the carcass and extending laterally between at least the first driving lug and at least the second driving lug. The reinforcing portion is configured to reinforce the inner portion of the carcass and support weight of the wheel.

In a fifth broad aspect of the present technology, there is provided a vehicle. The vehicle comprises a body, an engine supported by the body, and at least one track system. The at least one track system includes a sprocket wheel having a rim and a plurality of engaging elements extending laterally from a longitudinal center plane of the track assembly, the sprocket wheel defining a plurality of grooves between the plurality of engaging elements. The at least one track system includes an endless track engageable with the wheel. The endless track includes a polymeric carcass. The carcass includes an outer portion with an outer surface for contacting a ground surface. The carcass includes an inner portion with an inner surface opposite to the outer surface. A first lateral surface of the carcass extends between the inner and outer surfaces, and a second lateral surface of the carcass opposite to the first lateral surface and extends between the inner and outer surfaces. The carcass includes a plurality of driving lugs configured to engage the wheel and disposed on the inner surface proximate to the first and second lateral surfaces, the plurality of driving lugs extending radially inwardly from the inner surface and being longitudinally spaced from one another along the inner surface. The plurality of driving lugs includes a first driving lug disposed proximate to the first lateral surface and a second driving lug disposed proximate to the second lateral surface. The carcass includes a plurality of members disposed in the carcass, the plurality of members extends laterally in the inner portion of the carcass and being longitudinally spaced from one another along the carcass. A given member from the plurality of members has a guiding portion configured to engage the wheel and extending radially inwardly from the inner surface of the inner portion of the carcass, and a reinforcing portion located in the inner portion of the carcass and extending laterally between at least the first driving lug and at least the second driving lug. The reinforcing portion is configured to reinforce the inner portion of the carcass and support weight of the wheel.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track assembly and components in relation thereto, such as “vertical”, “horizontal”, “forwardly”, “rearwardly”, “left”, “right”, “above” and “below”, are as they would be understood by a driver of a vehicle to which the track assembly is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 shows a perspective view of a military vehicle in accordance with some embodiments of the present technology.

FIG. 2 shows a side elevation view of a harvesting vehicle in accordance with some embodiments of the present technology.

FIG. 3 shows a perspective view of a sprocket wheel in accordance with some embodiments of the present technology.

FIG. 4 shows a perspective view of a segment of an endless track in accordance with some embodiments of the present technology.

FIG. 5A shows a top view of the endless track of FIG. 4.

FIG. 5B shows an other top view of the endless track of FIG. 4.

FIG. 5C shows a top view of a simplified representation of a conventional endless track.

FIG. 5D shows a top view of a simplified representation of the endless track of FIG. 4.

FIG. 5E shows a top view of a simplified representation of an other endless track in accordance with some embodiments of the present technology.

FIG. 5F shows a top view of a simplified representation of an additional endless track in accordance with some embodiments of the present technology.

FIG. 6 shows an other perspective view of the endless track of FIG. 4.

FIG. 7A shows a bottom view of the endless track of FIG. 4.

FIG. 7B shows an other bottom view of the endless track of FIG. 4.

FIG. 8A shows a side elevation view of the endless track of FIG. 4.

FIG. 8B shows an other side elevation view of the endless track of FIG. 4.

FIG. 9A shows a cross-sectional view of the endless track of FIG. 4 taken through a line 9-9 of FIG. 5B.

FIG. 9B shows an other cross-sectional view of the endless track of FIG. 4 taken through the line 9-9 of FIG. 5B.

FIG. 9C shows a perspective view of a member of the endless track of FIG. 4.

FIG. 10 shows a partial, perspective view of a military vehicle with an other endless track in accordance with some embodiments of the present technology.

FIG. 11A shows a perspective view of a section of a conventional endless track.

FIG. 11B shows a perspective view of the endless track of FIG. 10.

FIG. 12A shows an other perspective view of the conventional endless track of FIG. 11A.

FIG. 12B shows an other perspective view of the endless track of FIG. 10.

FIG. 13A shows a cross-sectional view of the endless track of FIG. 10.

FIG. 13B shows an other cross-sectional view of the endless track of FIG. 10.

FIG. 13C shows an additional cross-sectional view of the endless track of FIG. 10.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology relates to various embodiments of an endless track, which will be described with reference to a track system. The endless track according to some embodiments of the present technology comprises a carcass and a given member extending in an inner portion of the carcass. The given member may comprise a first portion extending inwardly from the inner surface of the carcass for guiding a wheel of the track system. The given member may comprise a second portion extending laterally in the carcass for reinforcing the carcass and supporting weight of the vehicle. The second portion may be located in the inner portion of the carcass which may increase durability of the endless track and/or reduce a width of the endless track. The location of the second portion in the carcass may allow better optimization of shape, size, and/or pattern of outer lugs for increasing traction, and/or reducing pressure on the ground surface and/or increase durability of the endless track.

### Vehicles & Track Systems

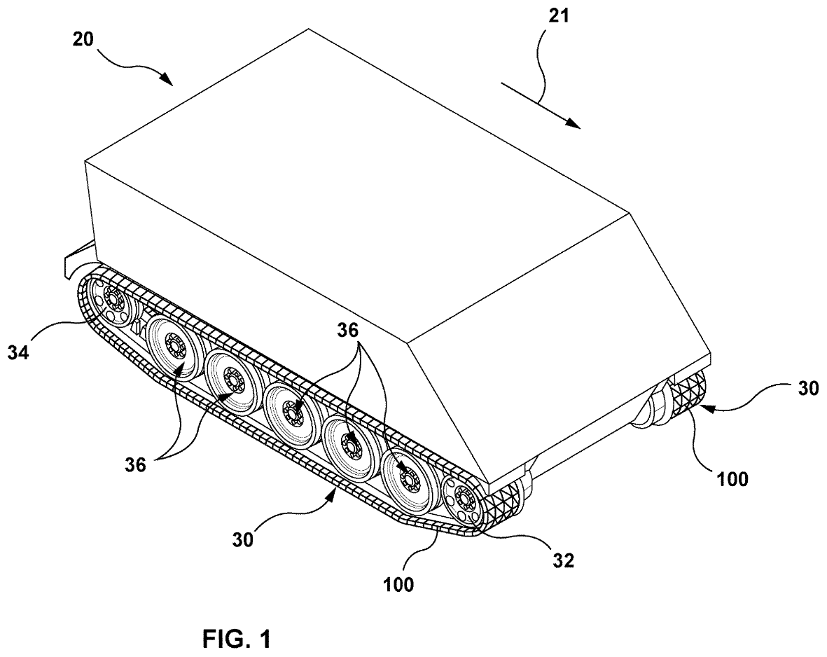

Referring to FIG. 1, the present technology will be described with reference to a military vehicle 20. Specifically, the military vehicle 20 is an armored personnel carrier 20, the forward direction of which is indicated by arrow 21. The military vehicle 20 has, on either side thereof, track systems 30. Each of the track systems 30 has a sprocket wheel assembly 32 mounted to a front end of the military vehicle 20, an idler wheel assembly 34 mounted at a rear end of the military vehicle 20 and five road wheel assemblies 36 mounted along a length of the military vehicle 20. It is contemplated that there could be more or less than five road wheel assemblies. Each of the track systems 30 also includes an endless track 100 that surrounds the sprocket wheel assembly 32, the idler wheel assembly 34 and the road wheel assemblies 36.

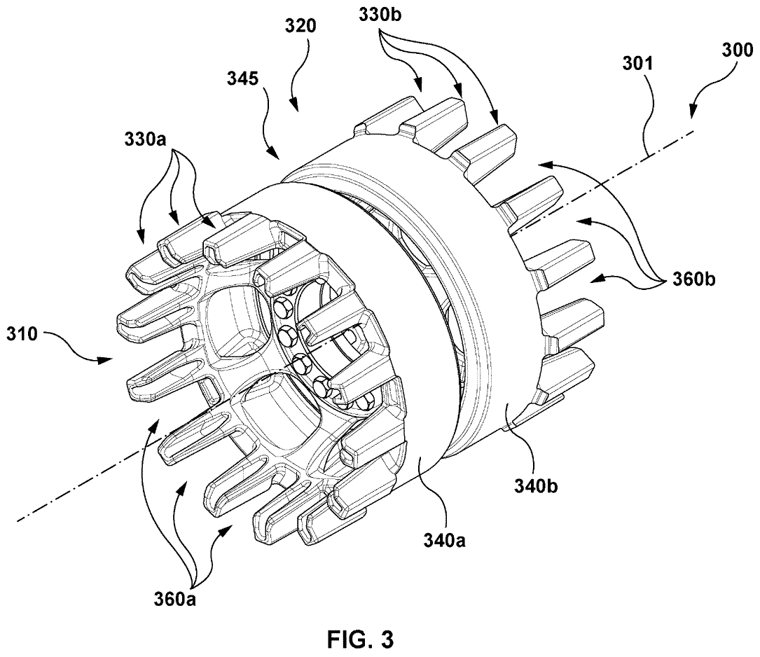

The sprocket wheel assembly 32 is generally configured to engage the endless track 100 and to transmit motive power from an engine (not shown) of the military vehicle 10 to the endless track 100. How the sprocket wheel assembly 32 may be implemented in some embodiments of the present technology will be described in greater detail herein further below with reference to FIG. 3.

The idler wheel assembly 34 is configured to adjust tension and to guide the endless track 100. The road wheel assemblies 36 are generally configured to guide a lower run portion of the endless track 100 which engages the ground during use.

In some embodiments of the present technology, the sprocket wheel assembly 32 may be mounted near the rear end of the military vehicle 20 and the idler wheel assembly 34 may be mounted near the front end of the military vehicle 20. It is contemplated that location(s) of one or more sprocket wheel assemblies and of one or more idler wheel assemblies may depend on inter alia weight distribution of the military vehicle 20. It is also contemplated that location(s) and a number of one or more road wheel assemblies may depend on inter alia weight distribution of the military vehicle 20.

It is contemplated that the present technology could be used with vehicles other than military vehicles. For example, the present technology could be used with other agriculture vehicles such as tractors, with industrial vehicles such as bulldozers, skid-steer loaders, excavators and compact track loaders, with military vehicles such as tanks, with utility vehicles, with exploratory vehicles and/or with all-terrain vehicles such as, side-by-side vehicles or utility-terrain vehicles. It is contemplated that the present technology could be used with vehicles having a high cargo-carrying capacity (e.g., 40 US tons and higher). It is also contemplated that the present technology could be used with trailers or other unpowered vehicles.

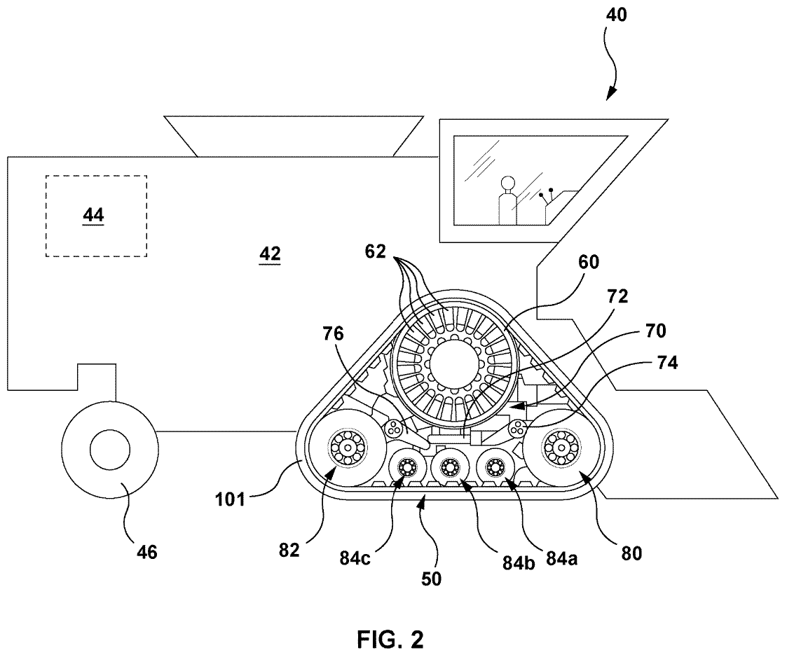

With reference to FIG. 2, there is depicted a harvester 40. The harvester 40 has a frame 42 that houses an engine 44 (shown schematically). The harvester 40 also has left and right rear wheels 46 and left and right track systems 50 (only right rear wheel 46 and right track system 50 are shown in the accompanying FIGS.). It is contemplated that in some embodiments, the harvester 40 could have more than two track systems. The engine 44 is operatively connected to left and right track systems 50. It is contemplated that in some embodiments, the engine 44 could be operatively connected to the rear wheels 46.

The track system 50 has a sprocket wheel assembly 60 that is operatively connected to an axle (not shown) of the harvester 40, such that when the axle rotates, the sprocket wheel assembly 60 also rotates, thereby driving the track system 50. It is contemplated that in some embodiments, the sprocket wheel assembly 60 could be configured to connect to a non-driving axle of a vehicle. How the sprocket wheel assembly 60 is implemented in some embodiments of the present technology will be described in greater detail herein further below with reference to FIG. 3.

The track system also has a frame 70 that is operatively connected to the sprocket wheel assembly 60 and that is disposed laterally inwardly therefrom. It is contemplated that in other embodiments, the frame 70 could be disposed laterally outwardly to the sprocket wheel assembly 60. In other embodiments, the frame 70 could be laterally aligned with the sprocket wheel assembly 60. The frame 70 has a main frame 72, a leading frame member 74 and a trailing frame member 76 where the leading and trailing frame members 74, 76 are pivotally connected to the main frame 72. It is understood that the frame 70 could differ from the above description without departing from the scope of the present technology. For example, in some embodiments, the frame 70 could be configured to not have any pivotally connected member.

The track system 50 further comprises a front idler wheel assembly 80, a rear idler wheel assembly 82 and three support wheel assemblies 84a, 84b, 84c that are disposed longitudinally between the front and rear idler wheel assemblies 80, 82. It is contemplated that in some embodiments, the track system 50 could have more or less than three support wheel assemblies.

The front idler wheel assembly 80 and the support wheel assembly 84a are rotationally connected to the leading frame member 74. The support wheel assemblies 84b, 84c are connected to form a tandem 86 which, in turn, is pivotally connected to the trailing frame member 76. The rear idler wheel assembly 82 is also rotationally connected to the trailing frame member 76. Thus, the track system 50 can, to some extent, conform to encountered obstacles.

Each one of the front and rear idler wheel assemblies 80, 82, and the support wheel assemblies 84a, 84b, 84c has two laterally spaced wheels, such that each one of the front and rear idler wheel assemblies 80, 82, and the support wheel assemblies 84a, 84b, 84c has left and right wheels (only right wheel of each of the wheel assemblies is shown in FIG. 1B). It is contemplated that in some embodiments, one or more of the front and rear idler wheel assemblies 80, 82, and the support wheel assemblies 84a, 84b, 84c could be configured to have a single wheel or three or more wheels in the lateral direction.

It is contemplated that in some embodiments, the track system 50 could include a tensioner that is configured to adjust tension in the endless track 101.

### Sprocket Wheel Assembly

With reference to FIG. 3, there is depicted a sprocket wheel 300 of the sprocket wheel assembly 32. It should be noted that the sprocket wheel of the sprocket wheel assembly 60 may be implemented in a similar manner, without departing from the scope of the present technology.

The sprocket wheel 300 is operatively connectable to an engine (not depicted), and is rotatable about a sprocket wheel axis 301. The sprocket wheel 300 defines a central aperture 310 that is generally aligned with the sprocket wheel axis 301. In some embodiments, the central aperture 310 is configured to partially receive an axle (not shown) of the vehicle 20 and/or the harvester 40.

The sprocket wheel 300 has a rim 320 and a plurality of engaging elements 330a, 330b extending laterally away from the rim 320.

The rim 320 includes middle annular rim portions 340a, 340b disposed on either lateral side of a central annular channel 345. It is contemplated that the middle annular portions 340a and 340b may be fastened to one another via one or more fasteners. For example, middle annular portions 340a and 340b may be fastened to one another using one or more bolts.

The central annular channel 345 is configured to receive part of a given endless track therein. It is contemplated that the rim 320 may further comprise a central annular rim portion that defines a central annular channel. In other embodiments, the central annular rim portion may define a plurality of apertures, instead of the central annular channel for receiving part of a given endless track.

The middle annular rim portions 340a, 340b are configured to support a part of the given endless track. The middle annular rim portions 340a, 340b have generally smooth radial surfaces that are free of edges. In other embodiments, however, a given side annular rim portion may have a polygonal lateral surface defining a plurality of edges.

The plurality of engaging elements 330a extends laterally outwardly from an edge of the middle annular rim portion 340a, and the plurality of the engaging elements 330b extends laterally outwardly from an edge of the middle annular rim portion 340b. The engaging elements 330a, 330b are circumferentially spaced around the middle annular rim portions 350a, 350b. The engaging elements 330a, 330b, which may by referred to as “teeth”, are configured to engage with a given endless track.

A plurality of recesses 360a is defined between the plurality of engaging elements 330a, and a plurality of recesses 360b is defined between the plurality of engaging elements 330b. More precisely, one of the recesses 360a is defined between two adjacent engaging elements 330a, and one of the recesses 360b is defined between two adjacent engaging elements 330b. As will be described below, the recesses 360a, 360b are configured to receive part of the given endless track therein.

In some implementations of the present technology, a pitch of the sprocket wheel 300 may be 120 mm. In other embodiments, a pitch of the sprocket wheel 300 may be in a range between 50 mm and 200 mm. In some implementations of the present technology, a radius of the sprocket wheel 300 may be 240 mm. In other embodiments, a radius of the sprocket wheel 300 may be in a range between 125 mm to 550 mm.

It is contemplated that the sprocket wheel assemblies envisioned in some embodiments of the present technology may have an “internal drive” configuration. Broadly, a sprocket wheel assembly in an internal drive configuration generally comprises laterally extending engaging elements configured to interact with inwardly extending driving lugs of an endless track. As opposed to an “external drive” configuration, where outwardly extending engaging elements of a sprocket wheel interact with laterally extending driving lugs of the endless track, internal drive configurations may allow reducing a width of the endless track. It is contemplated that narrower endless tracks may be beneficial in at least some implementations of the present technology.

The sprocket wheel assembly 300 is made of steel. It is contemplated that in some embodiments, the sprocket wheel assembly 300 could be made of other material such as ultra-high molecular weight polyethylene (UHMW). In other embodiments, the sprocket wheel assembly 300 could be made of steel covered by UHMW (which could assist in reducing noise generated thereby when engaging the given endless track).

In at least some implementations of the present technology, the sprocket wheel 300 may be embodied similarly to a sprocket wheel disclosed in U.S. Pat. No. 7,416,266, entitled “Sprocket wheel for heavy high speed multi-terrain vehicles”, granted on Aug. 26, 2008, the content of which is incorporated herein by reference in its entirety.

### Endless Tracks

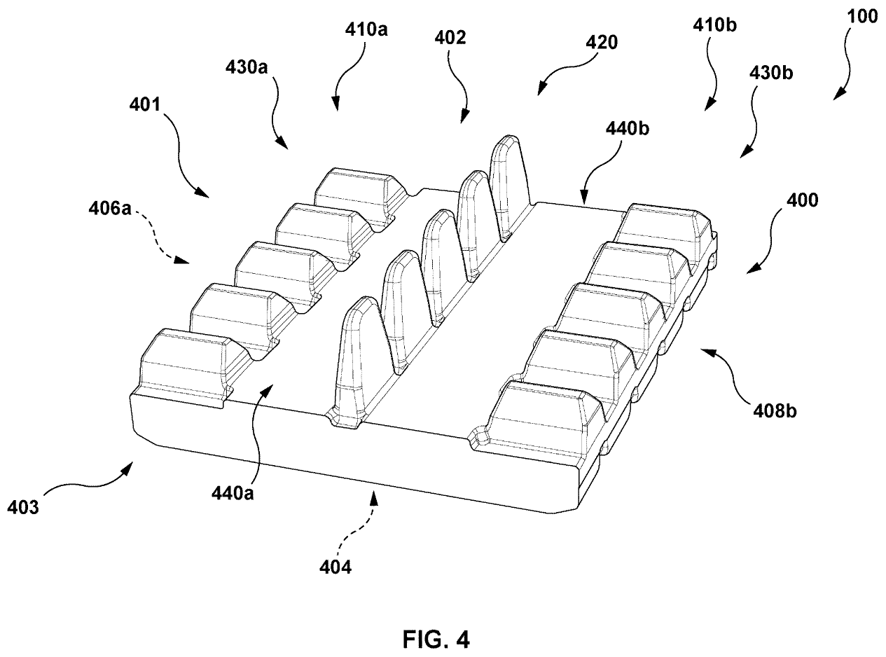

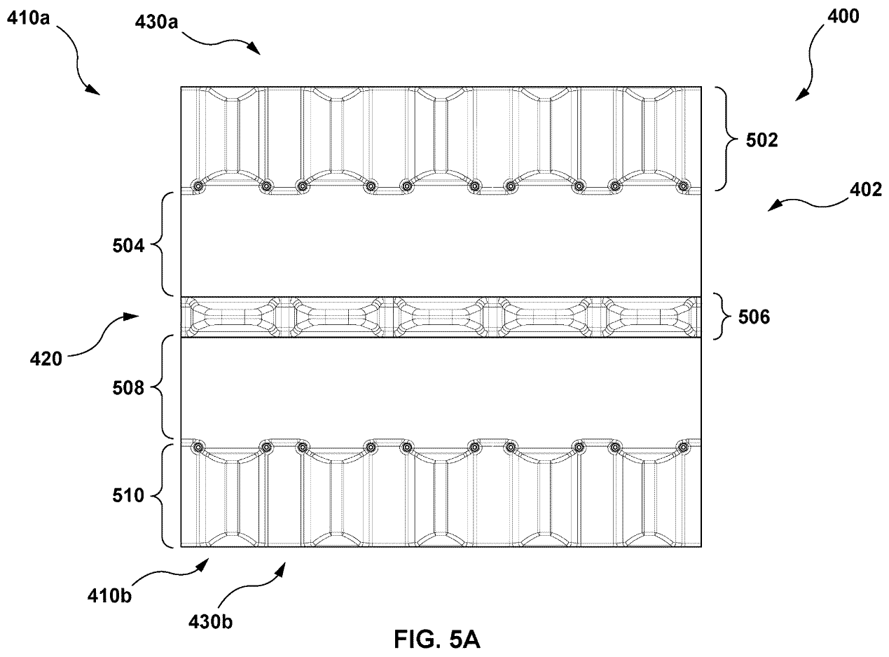

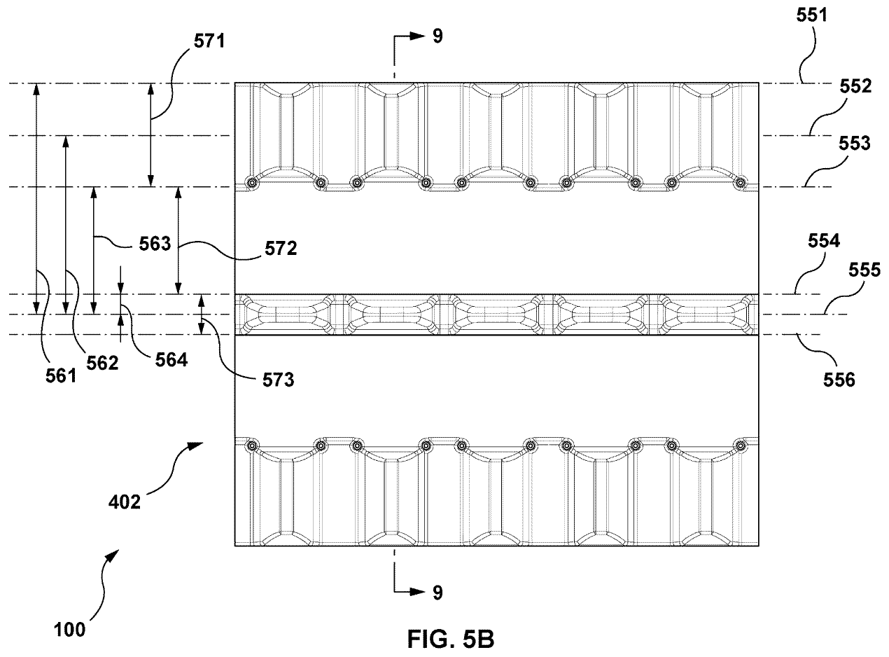

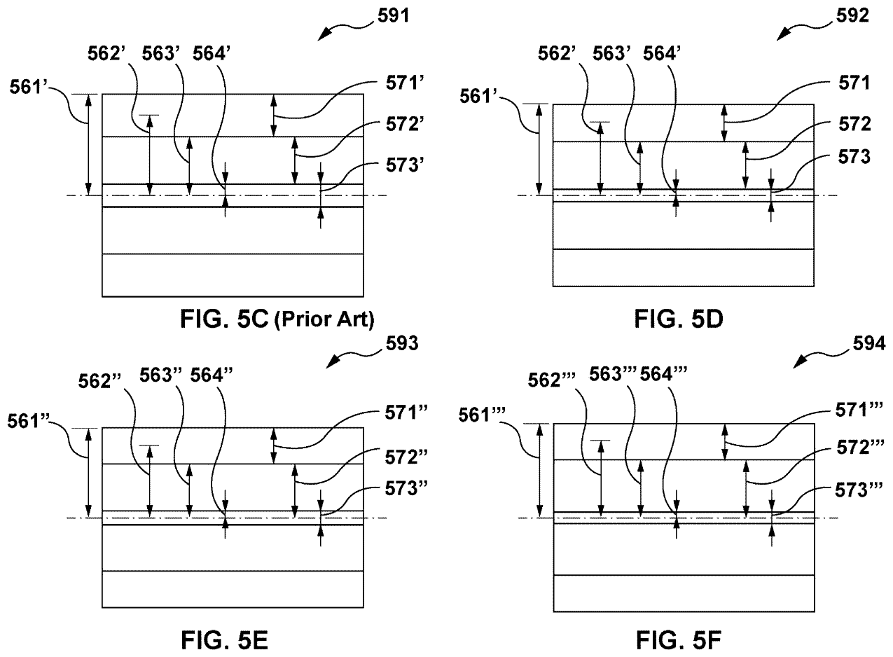

With reference to FIGS. 4 and 5, there is depicted a segment of the endless track 100. The endless track 100 comprises a body, or carcass 400. The carcass 400 has an inner surface 402 which is engageable with the sprocket wheel assembly 300, the idler wheel assembly 34 and the road wheel assemblies 36 (or the front and rear idler wheel assemblies 80, 82 and with the support wheel assemblies 84a, 84b, 84c in the case of the endless track 101). The carcass 400 has an outer surface 404 that is opposite to the inner surface 402, and that is engageable with a ground surface. The carcass 400 also has a first lateral surface 406 and a second lateral surface 408 that extend between the inner surface 402 and the outer surface 404.

It should be noted that the carcass 400 can be said to have at least two portions, an inner portion 401 with the inner surface 402 configured to engage with components of the track system 30, and an outer portion 403 with the outer surface 404 configured to engage with the ground surface.

In some embodiments, the carcass 400 is made of a polymeric material. It is contemplated that the polymeric material could be an elastomeric material such as, for example, rubber. Thus, the carcass 400 is flexible, thereby enabling it to conform to obstacles and/or components of the track system 30 such as the sprocket wheel assembly 300. When overcoming obstacles, and/or conforming to one of the pluralities of wheel assemblies, the endless track 100 can deform due to its resilient nature.

Focussing first on the inner surface 402 of the inner portion 401, the endless track 100 comprises a first plurality of driving (inner) lugs 410a proximate to the first lateral surface 406 and a second plurality of driving (inner) lugs 410b proximate to the second lateral surface 408. Driving lugs from the first plurality of driving lugs 410a and from the second plurality of driving lugs 410b extend inwardly (as opposed to laterally, for example) from the inner surface 402 and are longitudinally spaced along a longitudinal center plane of the endless track 100.

As previously alluded to, the first plurality of driving lugs 410a and the second plurality of driving lugs 410b are configured to engage with the sprocket wheel assembly 300. It should be noted that the inner surface 402 defines a first plurality of recesses 430a between the first plurality of driving lugs 410a and a second plurality of recesses 430b between the second plurality of driving lugs 410b. During operation, the first plurality of driving lugs 410a are received in the plurality of recesses 360a, the second plurality of driving lugs 410b are received in the plurality of recesses 360b, the plurality of engaging elements 330a are received in the first plurality of recesses 430a, and the plurality of engaging elements 330b are received in the second plurality of recesses 430b. As previously alluded to, the first plurality of driving lugs 410a and the second plurality of driving lugs 410b are arranged in an internal drive configuration.

Also, the endless track 100 comprises a wheel path 440a and a wheel path 440b. The wheel paths 440a and 440b are configured to support wheels of one or more wheel assemblies of a track system 30, including rim portions of the sprocket wheel assembly 300 and other wheel assemblies of the track system 30.

In at least some embodiments of the present technology, developers have devised an endless track with an optimized wheel path to a given performance metric of a corresponding track system. As it will become apparent from the description herein below, the inner portion of the carcass 400 may be provided with a given member that allows to (i) increase a width of at least one wheel path of the inner surface 402, and (ii) reduce a width of the carcass 400 itself. Increasing the width of at least one wheel path may reduce pressure applied onto the carcass 400. Reducing a width of the carcass 400 may facilitate installation of the carcass 400 on the track system 30 and/or reduce cost of the track system 30.

The endless track 100 also comprises a plurality of guiding lugs 420 along the longitudinal center plane of the endless track 100. The plurality of guiding lugs 420 is configured to engage with the sprocket wheel assembly 300, and other wheel assemblies of the track system 30 for guiding the endless track 100 relative to the wheel assemblies during operation. Guiding lugs from the plurality of guiding lugs 420 extend inwardly from the inner surface 402 (as opposed to laterally, for example) and are longitudinally spaced along the longitudinal center plane of the endless track 100.

In at least some embodiments of the present technology, developers of the present technology have devised a carcass with a given member that may at least partially extend into a corresponding guiding lug. As it will become apparent from the description herein below, the given member may reinforce the corresponding guiding lug and/or guide one or more wheel along the endless track 100. Reinforcing the corresponding guiding lug may allow reducing in width of the corresponding guiding lug in at least some implementations of the present technology.

With reference to FIG. 5A, the inner surface 402 can be said to have a plurality of zones, including a first driving zone 502, a first wheel path zone 504, a guiding zone 506, a second wheel path zone 508, and a second driving zone 510. The first plurality of driving lugs 410a and the first plurality of recesses 430a are located in the first driving zone 502 of the inner surface 402. The second plurality of driving lugs 410b and the second plurality of recesses 430b are located in the second driving zone 510 of the inner surface 402. The plurality of guiding lugs 420 is located in the guiding zone 506. The first wheel path 440a is located in the first wheel path zone 504. The second wheel path 440b is located in the second wheel path zone 508. It is contemplated that width of respective ones from the plurality of zones may be optimized for one or more performance metric of the track system 30 and/or a corresponding vehicle.

With reference to FIG. 5B, there is depicted lines 551 to 556. The lines 551 to 556 are parallel to one another. The line 551 follows an edge of the inner surface 402 and passes through a lateral outermost point of the first plurality of driving lugs 410a. The line 552 passes through a lateral center of the first plurality of driving lugs 410a. The line 553 passes through a lateral innermost point of the first plurality of driving lugs 410a and follows an outer edge of the first wheel path 440a. The line 554 passes through a first lateral outermost point of the plurality of guiding lugs 420 and follows an inner edge of the first wheel path 440a. The line 555 follows the longitudinal center plane of the endless track 100 and passes through a lateral center of the plurality of guiding lugs 420. The line 556 passes through a second, opposite lateral outermost point of the plurality of guiding lugs 420 and follows an inner edge of the second wheel path 440b.

The line 551 is located at a lateral distance 571 from the line 553. The lateral distance 571 represents a total width of the first plurality of driving lugs 410a. The lateral distance 571 also represents a total width of the first driving zone 502. In this embodiment, the lateral distance 571 is about 110 mm.

The line 553 is located at a lateral distance 572 from the line 554. The lateral distance 572 represents a total width of the first wheel path 440a and/or of the first wheel path zone 504. In this embodiment, the lateral distance 572 is 137.5 mm.

The line 554 is located at a lateral distance 573 from the longitudinal line 556. The lateral distance 573 represents a total width of the plurality of guiding lugs 420. The lateral distance 573 also represents a total width of the guiding zone 506. In this embodiment, the lateral distance 573 is about 35 mm.

The line 551 is located at a lateral distance 561 from the line 555. The lateral distance 561 represents half of a total width of the endless track 100. In this embodiment, the lateral distance 561 is 265 mm (530 mm/2=265 mm). The line 552 is located at a lateral distance 562 from the line 555. The lateral distance 562 represents a lateral distance between a lateral center of the plurality of guiding lugs 420 and the lateral center of the first plurality of driving lugs 410a. In this embodiment, the lateral distance 562 is 210 mm (distance 561−(distance 571/2)=265 mm−(110 mm/2 )=210 mm). The line 553 is located at a lateral distance 563 from the line 555. In this embodiment, the lateral distance 563 is 155 mm (distance 561−distance 571=265 mm−110 mm=155 mm). The line 554 is located at a lateral distance 564 from the line 555. The lateral distance 564 represents half of a total width of the plurality of guiding lugs 420. In this embodiment, the lateral distance 564 is 17.5 mm (distance 573/2=35 mm/2=17.5 mm).

In some implementations of the present technology, a ratio of the lateral distance 573 over the lateral distance 572 is 0.255. In some implementations of the present technology, a ratio of the lateral distance 573 over the width of the carcass 400 is 0.066. In some implementations of the present technology, a ratio of the lateral distance 572 over the width of the carcass 400 is 0.259. In some implementations of the present technology, a ratio of the lateral distance 571 over the width of the carcass 400 is 0.208. In some implementations of the present technology, a ratio of the lateral distance 573 over twice the lateral distance 563 is 0.113.

With reference to FIG. 5C, there is depicted a simplified representation 591 of a conventional endless track. A lateral distance 561′ represents half of a total width of the conventional endless track. The lateral distance 561′ is 294 mm. A lateral distance 562′ represents a lateral distance between a lateral center of a plurality of guiding lugs and a lateral center of a plurality of driving lugs. The lateral distance 562′ is 232 mm. A lateral distance 563′ represents a lateral distance between a lateral center of a plurality of driving lugs and an outer edge of a wheel path. The lateral distance 563′ is 170 mm. A lateral distance 564′ represents half of a total width of plurality of guiding lugs. The lateral distance 564′ is 32.5 mm.

A lateral distance 571′ represents a total width of a plurality of driving lugs of the conventional track. The lateral distance 571′ is 124 mm. A lateral distance 572′ represents a total width of a wheel path. The lateral distance 572′ is 137.5 mm. A lateral distance 573′ represents a total width of a plurality of guiding lugs. The lateral distance 573′ is 65 mm.

A ratio of the lateral distance 573′ over the lateral distance 572′ is 0.473. A ratio of the lateral distance 573′ over the width of the conventional track is 0.111. A ratio of the lateral distance 572′ over the width of the conventional track is 0.234. A ratio of the lateral distance 571′ over the width of the conventional track is 0.211. A ratio of the lateral distance 573′ over twice the lateral distance 563′ is 0.191.

With reference to FIG. 5D, there is depicted a simplified representation 592 of the carcass 400 of FIG. 5B. The simplified representations 592 is depicted at a same scale as the simplified representation 591 of the conventional track seen in FIG. 5C.

In some embodiments, the lateral distance 572 may be between 120 mm and 155 mm. In other embodiments, the lateral distance 572 may be above 135 mm. In further embodiments, the lateral distance 572 may be below 150 mm.

In some embodiments, the lateral distance 573 may be 35 mm. In other embodiments, the lateral distance 573 may be between 20 mm and 80 mm. In further embodiments, the lateral distance 573 may be lower than 90 mm. In additional embodiments, the lateral distance 573 may be lower than 60 mm. In yet other embodiments, the lateral distance 573 may be lower than 40 mm.

In some embodiments, the ratio of the lateral distance 573 over the lateral distance 572 may be between 0.220 and 0.350. In other embodiments, the ratio of the lateral distance 573 over the lateral distance 572 may be below 0.400. In further embodiments, the ratio of the lateral distance 573 over the lateral distance 572 may above 0.200.

In some embodiments, the ratio of the lateral distance 573 over the width of the carcass 400 may be between 0.060 and 0.080. In other embodiments, the ratio of the lateral distance 573 over the width of the carcass 400 may be below 0.085. In further embodiments, the ratio of the lateral distance 573 over the width of the carcass 400 may be above 0.055.

In some embodiments, the ratio of the lateral distance 572 over the width of the carcass 400 may be between 0.210 and 0.280. In other embodiments, the ratio of the lateral distance 572 over the width of the carcass 400 may be above 0.205. In further embodiments, the ratio of the lateral distance 572 over the width of the carcass 400 may be below 0.290.

In some embodiments, the ratio of the lateral distance 571 over the width of the carcass 400 may be between 0.220 and 0.190. In other embodiments, the ratio of the lateral distance 571 over the width of the carcass 400 may be below 0.210. In other embodiments, the ratio of the lateral distance 571 over the width of the carcass 400 may be above 0.190.

In some embodiments, the ratio of the lateral distance 573 over twice the lateral distance 563 may be between 0.120 and 0.090. In other embodiments, the ratio of the lateral distance 573 over twice the lateral distance 563 may be below 0.180. In further embodiments, the ratio of the lateral distance 573 over twice the lateral distance 563 may be above 0.080.

With reference to FIG. 5E, there is depicted a simplified representation 593 of a carcass as envisioned in an other embodiment of the present technology. A lateral distance 561″ represents half of a total width of the carcass in the other embodiment. The lateral distance 561″ is 261 mm. A lateral distance 562″ represents a lateral distance between a lateral center of a plurality of guiding lugs and a lateral center of a plurality of driving lugs of the carcass in the other embodiment. The lateral distance 562″ is 208 mm. A lateral distance 563″ represents a lateral distance between a lateral center of a plurality of driving lugs and an outer edge of a wheel path of the carcass in the other embodiment. The lateral distance 563″ is 155 mm. A lateral distance 564″ represents half of a total width of a plurality of guiding lugs of the carcass in the other embodiment. The lateral distance 564″ is 17.5 mm.

A lateral distance 571″ represents a total width of a plurality of driving lugs of the carcass in the other embodiment. The lateral distance 571″ is 106 mm. A lateral distance 572″ represents a total width of a wheel path of the carcass in the other embodiment. The lateral distance 572″ is 137.5 mm. A lateral distance 573″ represents a total width of a plurality of guiding lugs of the carcass in the other embodiment. The lateral distance 573″ is 35 mm.

A ratio of the lateral distance 573″ over the lateral distance 572″ is 0.255. A ratio of the lateral distance 573″ over the width of the carcass in the other embodiment is 0.067. A ratio of the lateral distance 572″ over the width of the carcass in the other embodiment is 0.263. A ratio of the lateral distance 571″ over the width of the carcass in the other embodiment is 0.203. A ratio of the lateral distance 573″ over twice the lateral distance 563″ is 0.113.

With reference to FIG. 5F, there is depicted a simplified representation 594 of a carcass as envisioned in an additional embodiment of the present technology. A lateral distance 561″′ represents half of a total width of the carcass in the additional embodiment. The lateral distance 561″′ is 272.7 mm. A lateral distance 562″′ represents a lateral distance between a lateral center of a plurality of guiding lugs and a lateral center of a plurality of driving lugs of the carcass in the additional embodiment. The lateral distance 562″′ is 219.7 mm. A lateral distance 563″′ represents a lateral distance between a lateral center of a plurality of driving lugs and an outer edge of a wheel path of the carcass in the additional embodiment. The lateral distance 563′″ is 166.7 mm. A lateral distance 564″′ represents half of a total width of a plurality of guiding lugs of the carcass in the additional embodiment. The lateral distance 564″′ is 17.5 mm.

A lateral distance 571″′ represents a total width of a plurality of driving lugs of the carcass in the additional embodiment. The lateral distance 571″′ is 106 mm. A lateral distance 572″′ represents a total width of a wheel path of the carcass in the additional embodiment. The lateral distance 572″′ is 149.2 mm. A lateral distance 573′″ represents a total width of a plurality of guiding lugs of the carcass in the additional embodiment. The lateral distance 573″′ is 35 mm.

A ratio of the lateral distance 573″′ over the lateral distance 572″′ is 0.235. A ratio of the lateral distance 573″′ over the width of the carcass in the additional embodiment is 0.064. A ratio of the lateral distance 572″′ over the width of the carcass in the additional embodiment is 0.274. A ratio of the lateral distance 571″′ over the width of the carcass in the additional embodiment is 0.194. A ratio of the lateral distance 573″′ over twice the lateral distance 563′″ is 0.105.

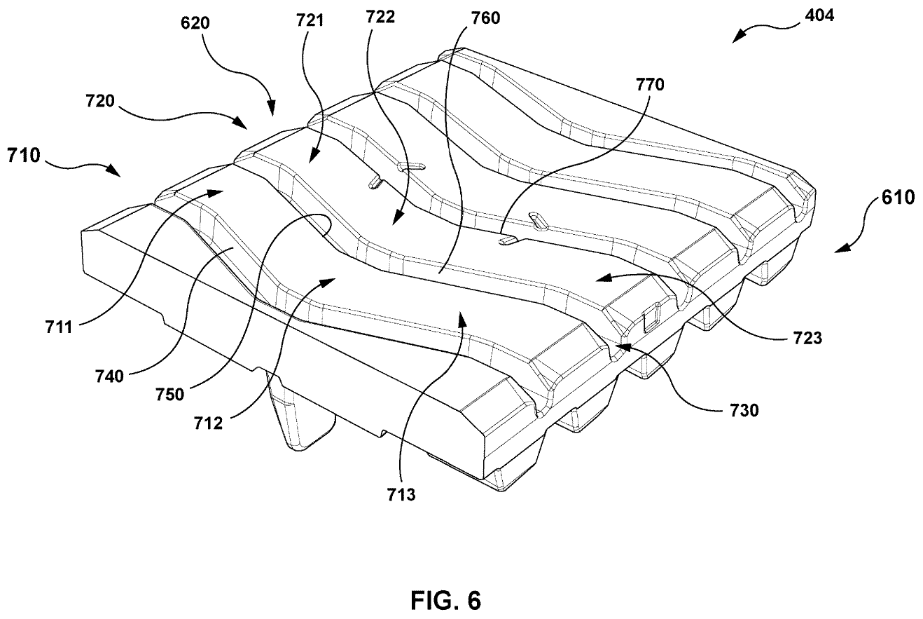

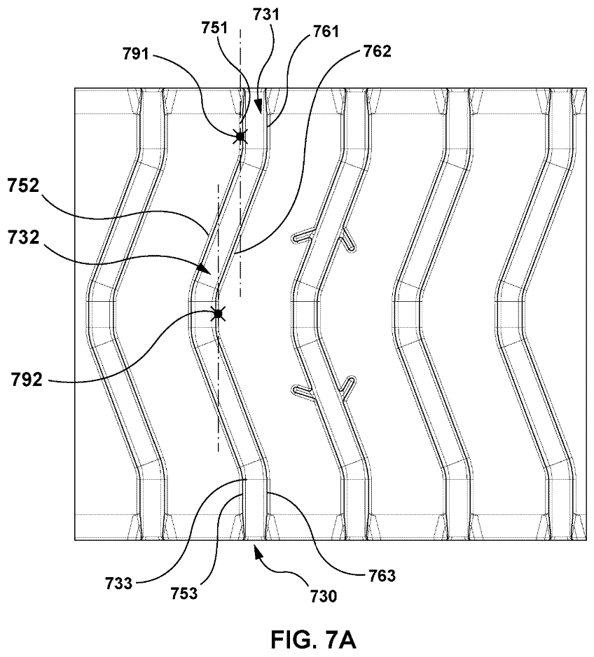

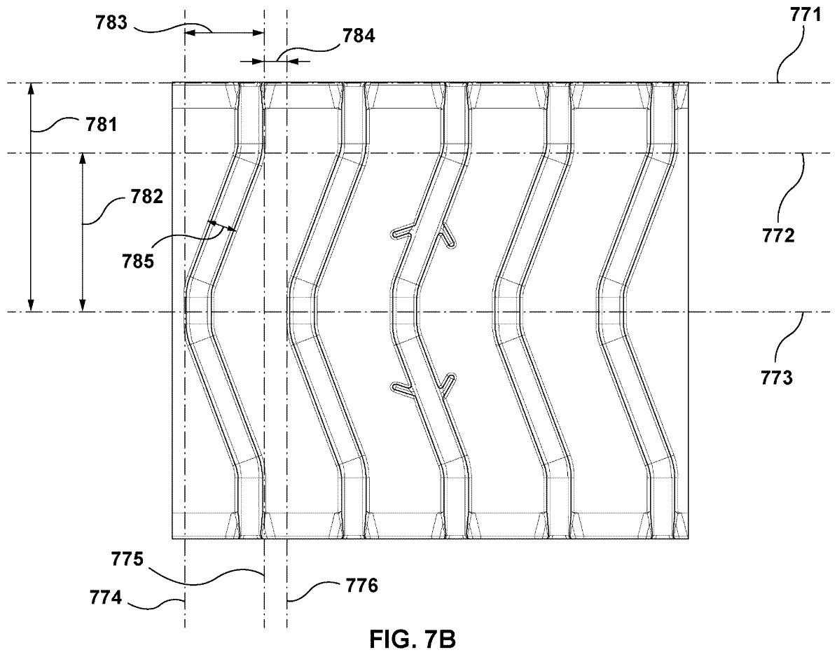

With reference to FIGS. 6 and 7A, the focus will now be shifted to the outer surface 404 of the carcass 400 seen in FIG. 5B. It should be noted however that the outer surface and side walls of the other embodiments of the carcass shown in FIGS. 5E and 5F can be implemented in a similar manner to the outer surface 404 and side walls of the carcass 400, without departing from the scope of the present technology.

The endless track 100 includes the plurality of outer lugs 610 which is engageable with the ground surface. As will be described in greater detail below, the shape of the outer lugs 610 can change from one embodiment to another without departing from the scope of the present technology. In some embodiments, the shape of the outer lugs 610 could change to conform to the ground surface which is to be engaged by the endless track 100. The outer lugs 610 extend from the outer surface 404, away therefrom, and are longitudinally spaced along the longitudinal center plane of the endless track 100.

Each one of the outer lugs 610 extends laterally along an entirety of a width of the endless track 100. It is contemplated that in some embodiments, the outer lugs 610 could extend along only a portion of the width of the endless track 100. In some embodiments, the outer lugs 610 could have varying width (e.g., one outer lug being wider than another outer lug). The spacing and width of the outer lugs 106 could vary depending on type of ground surface on which the endless track 100 is to be used.

The plurality of outer lugs 610 comprises a first outer lug 710 and a second outer lug 720 that is adjacent to the first outer lug 710. The first outer lug 710 comprises zones 711 to 713. The second outer lug 720 comprises zones 721 to 723. The zones 711, 712, 721, and 722 are generally straight across the width of the endless track 100. The zones 712 and 722 have a generally chevron-like shape. It can be said that the plurality of outer lugs 610 are non-linear across the width of the endless track 100.

The first outer lug 710 has a front wall 740 and a rear wall 750. The second outer lug 720 has a front wall 760 and a rear wall 770. The rear wall 750 comprises wall portions 751 to 753. The front wall 760 comprises wall portions 761 to 763. The rear wall 750 of the first outer lug 710 and the front wall 760 of the second outer lug 720 define a channel 730. The channel 730 comprises a channel portion 731 defined between the wall portions 751 and 761, a channel portion 732 defined between the wall portions 752 and 762, a channel portion 733 defined between the wall portions 753 and 763. The channel portions 731 and 733 are generally straight across the width of the endless track 100. The channel portion 732 has a generally chevron-like shape. It can be said that the plurality of channels 620 are non-linear across the width of the endless track 100. It can be said that a frontmost point 792 along the front wall 760 of the second outer lug 720 is longitudinally forward from a rearmost point 791 along the rear wall 750 of the first outer lug 710.

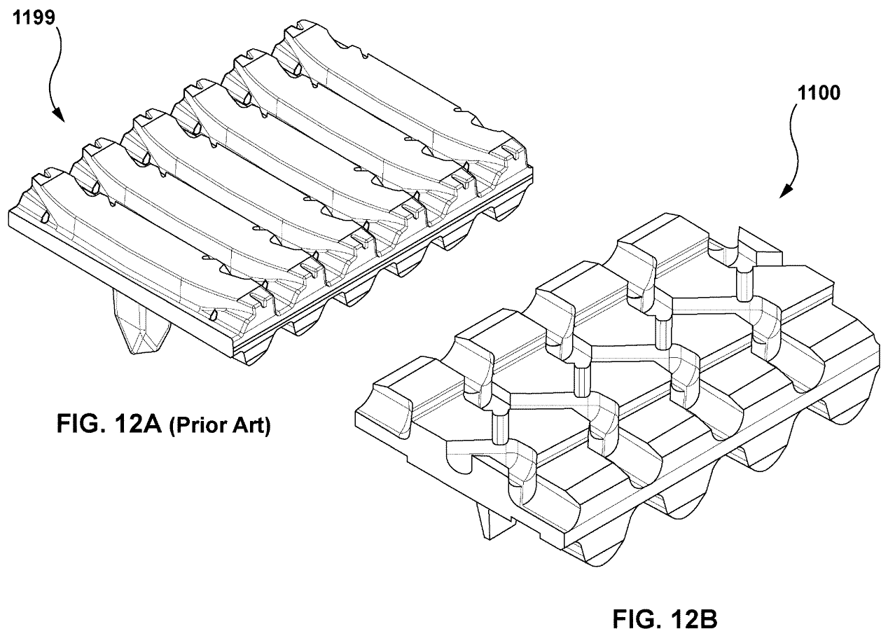

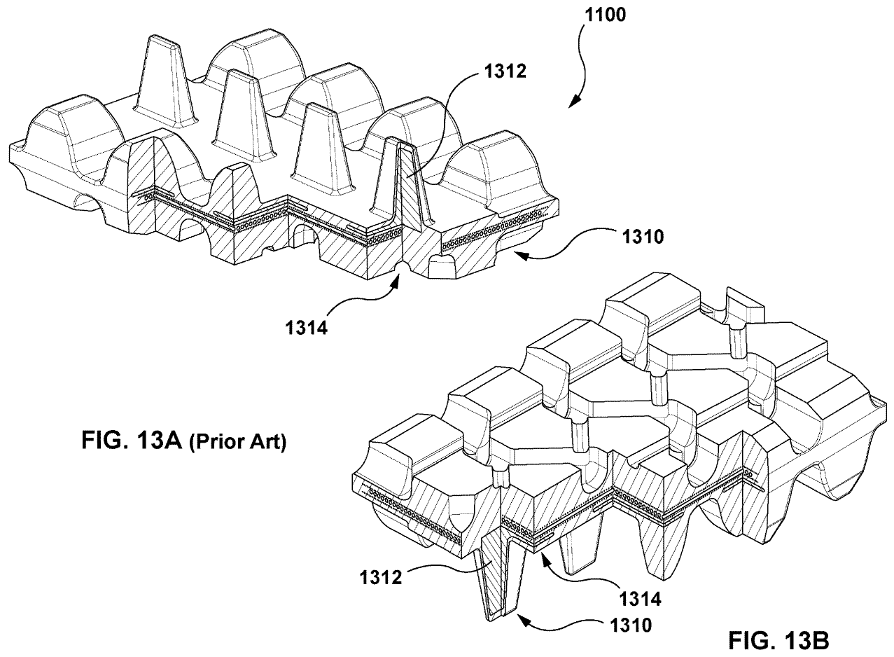

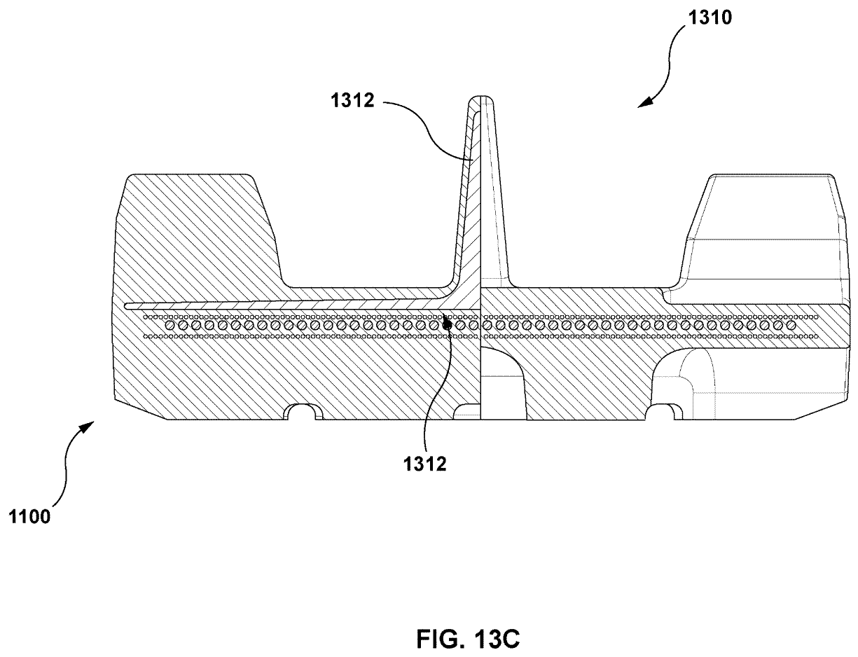

It is contemplated that shape, size and/or pattern of outer lugs may reduce lateral slip of the endless track 100. It is contemplated that the pattern of the outer lugs may vary depending on inter alia various implementations of the present technology. For instance, the pattern of the outer lugs may be designed to provide traction when an endless track 100 is driven in a first direction and a second, opposite, direction. Developers have realized that providing a “bi-directional” pattern on an endless track may at least partially aid for moving forward and/or rearward and/or rotating the corresponding vehicle. In another instance, the pattern of the outer lugs may be designed to prevent discovery of direction of travel of a corresponding vehicle based on a visual analysis of a footprint of the endless track on the ground surface. Developers have realized that providing a “bi-directional” pattern on an endless track may aid in concealing a direction of travel of the corresponding vehicle, which is beneficial in at least some applications of the present technology. With a brief reference to FIGS. 12B and 13B, there is depicted an endless track 1100 with outer lugs arranged in a bi-directional pattern, as envisioned in at least some embodiments of the present technology.

With reference to FIG. 7B, there is depicted lines 771 to 773 and lines 774 to 776. The lines 771 to 773 are parallel to one another. The lines 774 to 776 are parallel to one another. The lines 771 to 773 are orthogonal to the lines 774 to 776. The line 771 follows an edge of the inner surface 402 and passes through a lateral outermost point of the outer lugs 610. The line 772 passes between the zone 711 and the zone 712. The line 773 extends along a longitudinal center plane of the endless track 100. The line 774 passes through a frontmost point of a first channel, the line 775 passes through a rearmost point of the first channel, and the line 775 passes through a frontmost point of a subsequent channel.

In this embodiment, a lateral distance 781 between the lines 771 and 773 is 265 mm. In this embodiment, a lateral distance 782 between the lines 772 and 773 is 179.3 mm. In this embodiment, a longitudinal distance 783 between the lines 774 and 775 is 89.72 mm. In this embodiment, a longitudinal distance 784 between the lines 775 and 776 is 30.28 mm. A width 785 of the first channel is 29.72 mm.

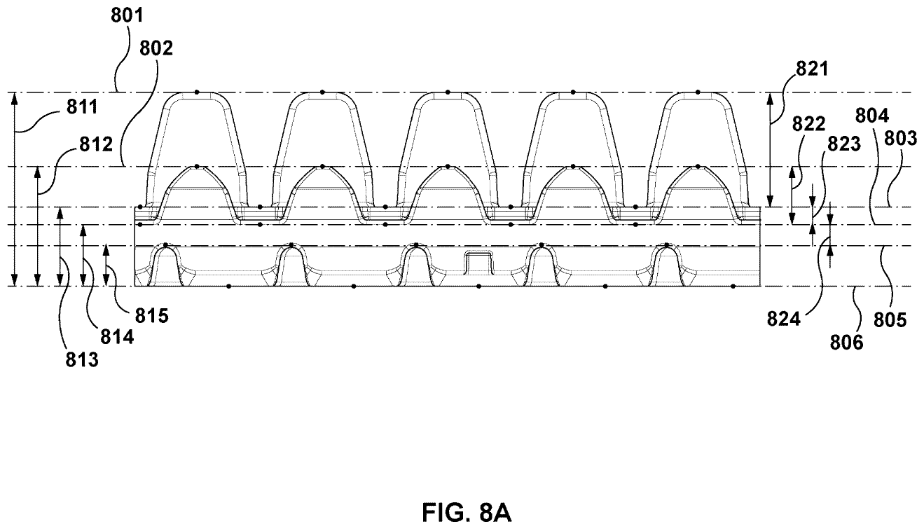

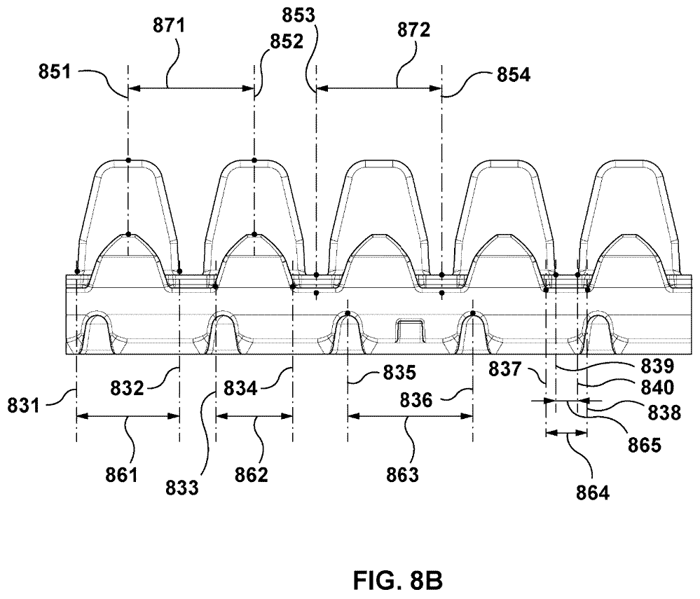

With reference to FIG. 8A, there is depicted lines 801 to 806. The lines 801 to 806 are parallel to one another. The line 801 passes through top points of the plurality of guiding lugs 420. The line 802 passes through top points of the plurality of driving lugs 410b. The line 803 is aligned with the inner surface 402 and the wheel paths 440a and 440b. The line 804 passes through bottom points of the plurality of recesses 430b. The line 805 passes through deepest points of the plurality of channels 620. The line 806 passes through bottom points of the plurality of outer lugs 610.

In this embodiment, a vertical distance 811 between the lines 801 and 806 corresponds to a total height of the endless track 100 and is 185.15 mm. In this embodiment, a vertical distance 812 between the lines 802 and 806 is 114.25 mm. In this embodiment, a vertical distance 813 between the lines 803 and 806 is 75.15 mm. In this embodiment, a vertical distance 814 between the lines 804 and 806 is 62.75 mm. In this embodiment, a vertical distance 815 between the lines 805 and 806 corresponds to height of the outer lugs 610 and is 37 mm.

In this embodiment, a vertical distance 821 between the lines 801 and 803 corresponds to a height of the plurality of guiding lugs 420 and is 110 mm. In this embodiment, a vertical distance 822 between the lines 802 and 804 corresponds to a heigh of driving lugs and is 51.5 mm. In this embodiment, a vertical distance 823 between the lines 803 and 804 is 12.4 mm. In this embodiment, a vertical distance 824 between the lines 804 and 805 is 25.75 mm.

With reference to FIG. 8B, there is depicted lines 831 to 840 and lines 851 to 854. The lines 831 to 840 and the lines 851 to 854 are parallel to one another. The line 831 passes through a frontmost point of a given guiding lug. The line 832 passes through a rearmost point of the given guiding lug. The line 833 passes through a frontmost point of the given driving lug. The line 834 passes through a rearmost point of the given driving lug. The line 835 passes through a bottom point of a given channel. The line 836 passes through a bottom point of a subsequent channel. The lines 837 and 838 pass through closest points of a pair of sequential driving lugs. The lines 839 and 840 pass through closest points of a pair of sequential guiding lugs. The lines 851 and 852 pass through top points of a pair of sequential driving lugs. The lines 851 and 852 also pass through top points of a pair of sequential guiding lugs. The lines 853 and 854 pass through bottom points of a pair of sequential recesses.

In this embodiment, a horizontal distance 861 between the lines 831 and 832 corresponds to a length of a given guiding lug and is 97.5 mm. In this embodiment, a horizontal distance 862 between the lines 833 and 834 corresponds to a length of a given driving lug and is 75 mm. In this embodiment, a horizontal distance 863 between the lines 835 and 836 corresponds to a length of a given outer lug and is 120 mm. In this embodiment, a horizontal distance 864 between the lines 837 and 838 corresponds to a spacing between two sequential driving lugs and is 45 mm. In this embodiment, a horizontal distance 865 between the lines 839 and 840 corresponds to a spacing between two sequential guiding lugs and is 22.5 mm. In this embodiment, a horizontal distance 871 between the lines 851 and 852 corresponds to a peak-to-peak distance and is 120 mm. In this embodiment, a horizontal distance 872 between the lines 853 and 854 corresponds to a guiding lug pitch and to a driving lug pitch and is 120 mm.

In this embodiment, a ratio of the guiding lug pitch over the driving lug pitch is equal to 1. In other embodiments, the ratio of the guiding lug pitch over the driving lug pitch may be higher or lower than 1. In this embodiment, a ratio of the guiding lug pitch over the outer lug pitch is equal to 1. In other embodiments, the ratio of the guiding lug pitch over the outer lug pitch may be higher or lower than 1. In this embodiment, the ratio of the driving lug pitch over the outer lug pitch is equal to 1. In other embodiments, the ratio of the driving lug pitch over the outer lug pitch may be higher or lower than 1.

It this embodiment, although the guiding lug pitch and/or the driving lug pitch (see distance 872) is equal to the outer lug pitch (see distance 863), there is a longitudinal offset between a given outer lug and a corresponding driving lug and a corresponding guiding lug. This longitudinal offset may result in a “hinge effect” that provides flexibility to the carcass. However, it should be noted that a given outer lug may be aligned with a corresponding driving lug and/or a corresponding guiding lug in other embodiments of the present technology.

Developers have realized that conventional endless tracks often include additional laterally extending reinforcing members in the outer portion of a carcass which limits a position of an outer lug relative to the corresponding driving lug and/or the corresponding guiding lug. In other words, an outer lug is often aligned with the guiding lug and/or the driving lug in prior art solutions that include an additional laterally extending reinforcing member in the outer portion of a carcass. As it will become apparent from the description herein further below, employing a member 910, for example, may dispense with a need to provide additional laterally extending reinforcing members in the outer portion of a carcass, which may allow designing a carcass with a longitudinal offset between a given outer lug and a corresponding driving lug and/or a corresponding guiding lug, and which in turn may result in the “hinge effect” described above.

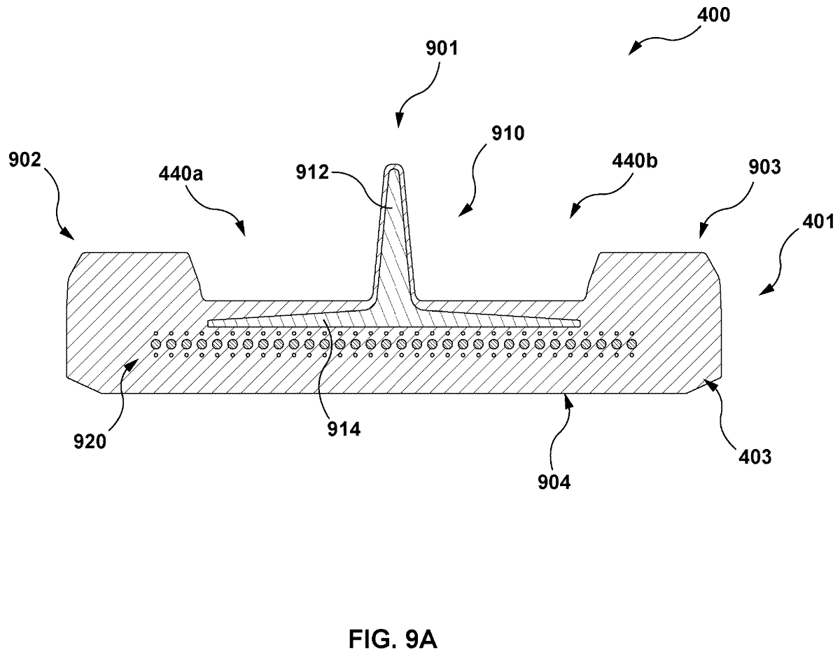

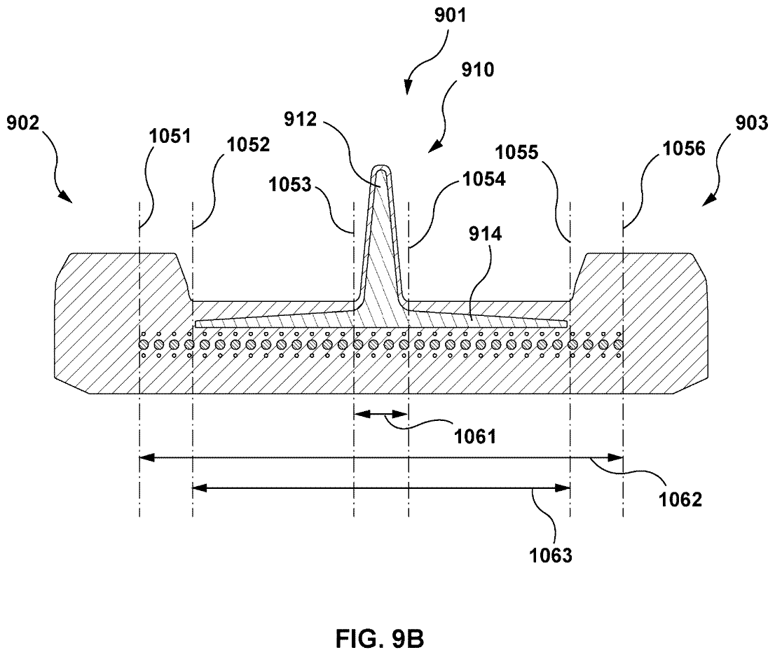

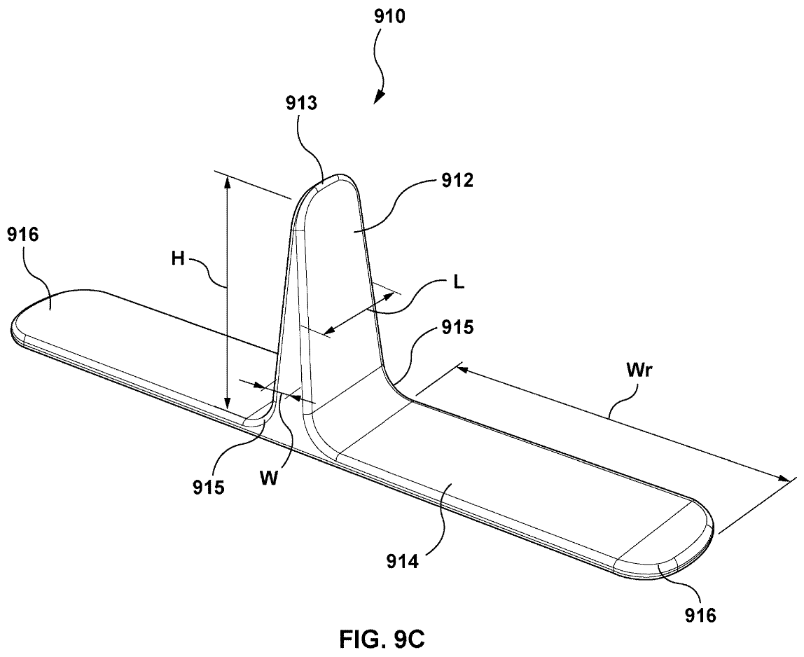

With reference to FIG. 9A, there is depicted a cross-sectional view of the carcass 400 taken through a line 9-9 of FIG. 5B. A member 910 can be seen disposed in the carcass 400. The member 910 extends laterally in the inner portion 401 of the carcass 400. It is contemplated that the carcass 400 comprises a plurality of members embodied similarly to the member 910 and where the members are longitudinally spaced from one another along the carcass 400.

Referring to FIGS. 9A to 9C, the member 910 comprises a guiding portion 912 configured to engage a given wheel of the track system 30 and extends radially inwardly from the inner surface 402 of the inner portion 401 of the carcass 400. The guiding portion 912 extends into a guiding lug 901, thereby reinforcing the guiding lug 901. The guiding portion 912 is tapered in the vertical direction as seen from a front thereof. More specifically, a width W of the guiding portion 912 varies along a height H thereof, with the width W of the guiding portion 912 at its base being greater than the width W of the guiding portion 912 at its peak. In some embodiments, the width W of the guiding portion 912 may be uniform along its height H. In other embodiments, the guiding portion 912 can be tapered in the vertical direction as seen from a side thereof. For example, a length L of the guiding portion 912 may vary along the height H thereof, with the length L of the guiding portion 912 at its base being greater than the length L of the guiding portion 912 at its peak. It can also be said that the height H of the guiding portion 912 varies along the length L thereof, with the height H being greatest midway through the length L of the guiding portion 912. As best seen in FIG. 9C, the guiding portion 912 has, at its peak, a curved end 913.

The member 910 comprises a reinforcing portion 914 located in the inner portion 401 of the carcass 400 and extending laterally between at least a first driving lug 902 and at least a second driving lug 903. It can be said that the reinforcing portion 914 is located under the wheel paths 440a and 440b and configured to support the weight of a given vehicle. The reinforcing portion 914 is configured to reinforce the inner portion 401 of the carcass 400. The reinforcing portion 914 extends laterally from the guiding portion 912. Fillets 915 are defined between the guiding portion 914 and the reinforcing portion 914. The fillets 915 can assist in decreasing stress concentrations within the member 910. In the reinforcing portion 914 illustrated in FIG. 9C, the reinforcing portion 914 is generally flat, and has a generally uniform height (sometimes referred to as “thickness”). In some embodiments, a ratio between the width of the base of the guiding portion 912 over the thickness of the reinforcing portion 914 could be about 4 to 1. In other embodiments, a ratio between the width of the curved end 913 of the guiding portion 912 over the thickness of the reinforcing portion 914 could be about 1 to 1. In other embodiments, notably the reinforcing portion 914 illustrated in FIGS. 9A and 9B, the height of the reinforcing portion 914 varies along a width of the reinforcing portion 914, with the height of the reinforcing portion 914 being greater closer to the guiding portion 912 than further therefrom). At each lateral end thereof, the reinforcing portion 914 has curved ends 916. The curved ends 916 can assist in reducing stress concentrations in the member 910 and/or the carcass 102. In some embodiments, a ratio between a width Wr of the reinforcing portion 914 (the width Wr being measured between one of the curved ends 916 and the corresponding fillet 915) over the height H of the guiding portion 912 is about 1.5 to 1.

The member 910 is a T-shaped member, however, this might not be the case in each and every embodiment of the present technology. The guiding portion 912 and the reinforcing portion 914 are integrally formed. It is contemplated that the member 910 may be made from a rigid material. A rigid member, as opposed to a resilient member, for example, may be employed to avoid and/or reduce deformation and/or bending of the member so as to retain its shape when force is applied thereto during operation. It is contemplated that the rigidity of the integrally formed member may be provided at least in part by its geometrical configuration. For example, the member 910 with a T-shape and/or having a filled body (i.e., not hollow), may be more rigid than a member formed from a bent sheet metal and/or having a hollow body. It is also contemplated that the rigidity of the integrally formed member may be provided at least in part by the material used for manufacturing the member. For example, the member 910 manufactured using cast iron, titanium, steel, etc. may increase the rigidity thereof.

In at least some embodiments of the present technology, the guiding portion 912 may be exposed or, in other words, may not necessarily be covered by a layer of elastomeric material used to form the carcass 400. In these embodiments, at least some functionalities of the guiding lug may be performed by an exposed guiding portion.

A plurality of reinforcing cables 920 is embedded in the inner portion 401 of the carcass 102. Other configurations are contemplated. The reinforcing cables 920 are configured to generally distribute loads along the carcass 400, and/or limit longitudinal elongation of the carcass 400. In other words, the reinforcing cables 920 can longitudinally reinforce the carcass 400 while the reinforcing portion 914 can laterally reinforce the carcass 400, which can assist in reducing the likelihood of the endless track 100 from being torn and/or damaged, thereby prolonging life of the endless track 100.

As seen in FIG. 9A, the plurality of reinforcing cables 920 are arranged into layers of reinforcing cords. It should also be noted that the reinforcing portion 914 is disposed between the inner surface 401 and the plurality of reinforcing cords 920.

In some embodiments, it is contemplated that the reinforcing portion 914 may be located in the inner portion 401 of the carcass 400 and, in a sense, “sit” on one or more layers of the reinforcing cords 920. The reinforcing portion 914 may or may not be in direct contact with the reinforcing cords 920. Developers have realized that providing the reinforcing portion 914 in the inner portion 401 of the carcass 400 between the wheel paths 440a and 440b and one or more layers of the reinforcing cords 920 may help in avoiding the need for reinforcement members in the outer portion 403 of the carcass 400. Avoiding additional reinforcement members in the outer portion 403 of the carcass 400 may be beneficial as it reduces dimensional limitations on shape, size and/or patterns of outer lugs.

Developers have also realized that providing the reinforcing portion 914 in the inner portion 401 of the carcass 400 that between the wheel paths 440a and 440b and the one or more layers of the reinforcing cords 920 may reduce wear of the carcass 400 and/or of the one or more layers of reinforcing cords 920. Providing the reinforcing portion 914 that extends in the inner portion 401, as opposed to providing it in the outer portion 403, for example, provides a reinforcing barrier between a given wheel of the track system 30 and the layers of reinforcing cords 920, and aids in supporting and distributing weight of the given vehicle. It is contemplated that providing such a reinforcing barrier between the wheel and the reinforcing cords 920 may reduce the risk of the reinforcing cords 920 migrating in the carcass 400 and/or getting exposed.

With reference to FIG. 9B, there is depicted lines 1051 to 1056. The lines 1051 to 1056 are parallel to one another. A lateral distance 1062 between the lines 1051 and 1056 corresponds to a width of the layer of reinforcement cords 920 in the carcass 400. The lateral distance 1062 is 495.3 mm. A lateral distance 1063 between the lines 1052 and 1055 corresponds to a width of the reinforcing portion 914. The lateral distance 1063 is 350.3 mm. A lateral distance 1061 between the lines 1053 and 1054 corresponds to a width of the guiding portion 912. The lateral distance 1061 is between 80 mm and 19 mm.

While the above-described features enhance durability of the endless track 100 (i.e., increase life of the endless track 100) on their own, the combinations of the features described above are synergetic. In other words, the combinations have an impact greater than a sum of these combinations on the life of the endless track 100.

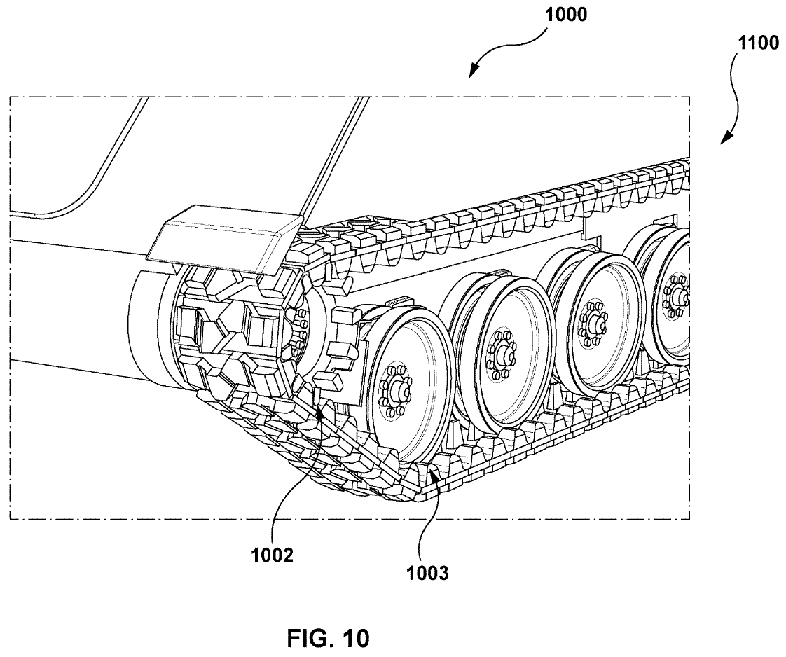

In another embodiment of the present technology, with reference to FIG. 10, there is provided an endless track 1100 configured to cooperate with a sprocket wheel 1002 and road wheel 1003 of a military vehicle 1000. It is contemplated that the endless track 1100 may comprise one or more members embodied similarly to the member 910 of the endless track 100. It may be desirable to provide an endless track 1100 with an increased width of corresponding road wheel paths for a pre-determined width of the carcass. For example, it may be desirable to increase a width of the road wheel paths while maintaining a total width of 530 mm for the corresponding carcass. In this example, providing members in the endless track 110 may help in reducing the width of corresponding guiding lugs and thereby provide additional room for increasing the width of the corresponding road wheel paths.

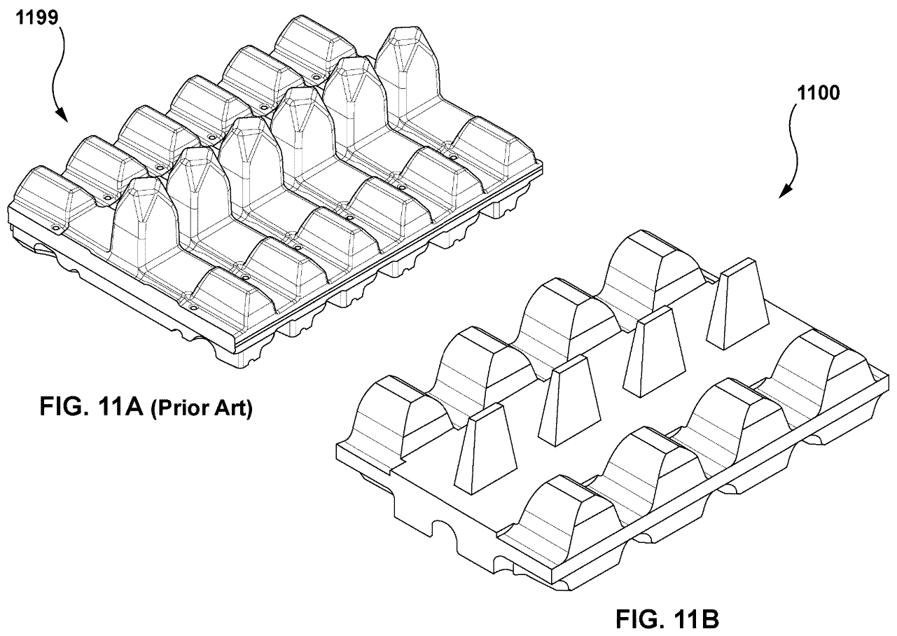

In FIG. 11A, there is provided a section of a conventional endless track 1199. In FIG. 11B, there is provided a section of the endless track 1100. As it can be seen, the endless track 1100 may have a comparatively larger driving lug pitch, comparatively larger guiding lug pitch, comparatively wider road wheel paths, and comparatively narrower guiding lugs.

In FIG. 12A, there is provided an other view of the section of the conventional endless track 1199. In FIG. 12B, there is provided an other view of the section of the endless track 1100. As it can be seen, the endless track 1100 may provide comparatively deeper outer lugs, comparatively longer outer lugs, and/or may have more complex outer lug patterns (e.g., bi-directional and non-linear).

In FIGS. 13A-C, there is depicted cross-sectional views of the section of the endless track 1100. As it can be seen, the endless track 1100 comprises a member 1310 having a guiding portion 1312 and a reinforcing portion 1314. In this embodiment, the reinforcing portion 1314 laterally extends in the carcass of the endless track 1100 along almost an entirety of a width of the carcass.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. An endless track for a track system, the endless track engageable with a wheel of the track system, the endless track comprising:
a polymeric carcass including:
an outer portion with an outer surface for contacting a ground surface; and
an inner portion with an inner surface opposite to the outer surface,
the outer portion having a first driving zone adjacent a first wheel path zone, the first wheel path zone adjacent a guiding zone, the guiding zone adjacent a second wheel path zone, the second wheel path zone adjacent a second driving zone;
a plurality of driving lugs configured to engage the wheel and disposed in the first and the second driving zones; the plurality of driving lugs extending radially inwardly from the inner surface and being longitudinally spaced from one another along the inner surface, the guiding zone comprising a plurality of members disposed in the carcass, the plurality of members extending laterally in the inner portion of the carcass and being longitudinally spaced from one another along the carcass,
a given member from the plurality of members having:
a guiding portion configured to engage the wheel and extending radially inwardly from the inner surface of the inner portion of the carcass, and
a reinforcing portion located in the inner portion of the carcass and extending laterally between at least the first driving lug and at least the second driving lug, the reinforcing portion configured to reinforce the inner portion of the carcass and support weight of the wheel;
the guiding zone having a width, the width of the guiding zone being half or less than half a width of the first driving zone and being zone being half or less than half a width of the second driving zone.

2. The endless track of claim 1, wherein the given member is a T-shaped member.

3. The endless track of claim 1, wherein the guiding portion and the reinforcing portion are integrally formed.

4. The endless track of claim 1, wherein the given member is made from a rigid material.

5. The endless track claim 1, wherein the plurality of members is a plurality of first members, the endless track further including:
at least one second member configured to reinforce the carcass, the at least one second member extending in the inner portion of the carcass longitudinally along a length of the carcass and about the plurality of first members, such that the reinforcing portion is located between the inner surface of the inner portion and the at least one second member.

6. The endless track of claim 5, wherein the at least one second member is a plurality of second members arranged into at least one layer of second members.

7. The endless track of claim 6, wherein the at least one layer of second members is a layer of reinforcing cords.

8. The endless track of claim 1, wherein the carcass further includes a guiding lug for guiding the wheel and disposed on the inner surface between the first driving lug and the second driving lug, the guiding portion extending into the guiding lug.

9. The endless track of claim 8, wherein the inner surface defines a wheel path located laterally between the first driving lug and the guiding lug, the wheel path configured to engage the wheel, the wheel path has a first width on the inner surface of the inner portion, the guiding lug having a second width on the inner surface of the inner portion, the first driving lug having a third width, and the carcass having a fourth width.

10-11. (canceled)

12. The endless track of claim 9, wherein the first width is between 120 mm and 155 mm.

13-14. (canceled)

15. The endless track of claim 9, wherein the second width is between 20 mm and 80 mm.

16. The endless track of claim 9, wherein a ratio of the second width over the first width is between 0.22 and 0.35.

17. The endless track of claim 9, wherein a ratio of the second width over the fourth width is between 0.06 and 0.08.

18. The endless track of claim 9, wherein a ratio of the first width over the fourth width is between 0.21 and 0.28.

19. The endless track of claim 9, wherein a ratio of the third width over the fourth width is between 0.21 and 0.19.

20-21. (canceled)

22. The endless track of claim 1, wherein the endless track further includes a plurality of non-linear outer lugs extending radially outwardly from the outer surface of the outer portion and longitudinally spaced from one another along the outer surface.

23. The endless track of claim 22, the plurality of non-linear lugs includes a first non-linear outer lug having a non-linear section extending laterally between the first and second lateral surfaces.

24. (canceled)

25. The endless track of claim 23, wherein the first non-linear outer lug further includes at least one linear section disposed proximate to at least one of the first and second lateral surfaces.

26. The endless track of claim 25, wherein the at least one linear section includes a first linear section and a second linear section, the first linear section disposed proximate to one of the first and second lateral surfaces and the second linear section disposed proximate to the other one of the first and second lateral surfaces.

27. The endless track claim 22, wherein the plurality of non-linear lugs defines a bi-directional pattern.

28-42. (canceled)
